(19) United States
(12) Patent Application Publication
(10) Pub. No.: US 2008/0201440 A1
(43) Pub. Date: Aug. 21, 2008

(54) Electronic Messaging Recordlessness Warning and Routing System and Method

(75) Inventors: Amit Jindas Shah, Livonia, MI (US); Joseph Collins, Darien, CT (US)

Correspondence Address: DOWNS RACHLIN MARTIN PLLC, 199 MAIN STREET, P O BOX 190, BURLINGTON, VT, 05402-0190, US

(73) Assignee: VOID COMMUNICATIONS, INC., Darien, CT (US)

(21) Appl. No.: 12/031,845

(22) Filed: Feb. 15, 2008

Related U.S. Application Data
(60) Provisional application No. 60/890,188, filed on Feb. 15, 2007.

(51) Int. Cl. G06F 15/16

(52) U.S. Cl. 709/206

(57) ABSTRACT

A system and method for monitoring an electronic message. Messaging information is received for inclusion in an electronic message. The messaging information is utilized to determine a desired degree of recordlessness for the electronic message. One or more electronic messaging functionalities for generating and/or transmitting the electronic message is chosen based on the desired degree of recordlessness.

### RELATED APPLICATION DATA

This application claims the benefit of priority of U.S. Provisional Patent Application Ser. No. 60/890,188, filed Feb. 15, 2007, and titled “Electronic Messaging Warning and Routing System and Method,” which is incorporated by reference herein in its entirety.

### FIELD OF THE INVENTION

The present invention generally relates to the field of electronic messaging. In particular, the present invention is directed to an electronic messaging recordlessness warning and routing system and method.

### BACKGROUND

Electronic messaging between and amongst parties typically involves creation of an electronic message on a sending device, communication of the electronic message via a network, and receipt of the electronic message on a recipient device. The electronic message may leave traces and be susceptible to interception at various points throughout the process. For example, messages may be cached, logged, archived and/or saved in one form or another after transmission from a sender, during transmission, and/or after receipt by a recipient. Additionally, messages may be copied, cut, pasted, printed, forwarded, blind copied, or otherwise manipulated. This can occur without the knowledge and/or consent of the sender.

### SUMMARY OF THE DISCLOSURE

In one embodiment, a computerized method of monitoring an electronic message at the point of generation is provided. The method includes receiving information from a user via an electronic interface for inclusion in an electronic message; determining a desired degree of recordlessness for the electronic message; and choosing an appropriate electronic messaging functionality for generating and/or transmitting the electronic message based on the desired degree of recordlessness.

In another embodiment, a computerized system for monitoring an electronic message at the point of creation is provided. The system includes a first electronic interface for receiving information for inclusion in one or more electronic messages from a sender, the one or more electronic messages for transmission to a recipient utilizing one or more electronic messaging functionalities, each of the one or more electronic messaging functionalities having a degree of recordlessness; a first database including a set of rules for determining a desired degree of recordlessness for the one or more electronic messages; and a message monitor in communication with the first electronic interface, the first database, and the one or more electronic messaging functionalities for monitoring information received by the first electronic interface and comparing at least part of the received information to the set of rules to determine the desired degree of recordlessness prior to transmission of the one or more messages and to determine if the degree of recordlessness of any of the one or more electronic messaging functionalities matches the desired degree of recordlessness.

In yet another embodiment, a system for electronic messaging is provided. The system includes a sender device including an interface for receiving information for inclusion in an electronic message; a first electronic messaging subsystem, the first electronic messaging subsystem having a first degree of recordlessness; a second electronic messaging subsystem, the second electronic messaging subsystem having a second degree of recordlessness that differs from the first degree of recordlessness; a first database including a set of rules for determining a status of the electronic message, the set of rules including criteria for determining the status based on whether the electronic message should be sent at the first or second degree of recordlessness; and a message monitor in communication with the interface, the first database, the first electronic messaging subsystem, and the second electronic messaging subsystem, the message monitor comparing the electronic message to the set of rules to determine the status prior to transmission of the electronic message.

In still another embodiment, a machine-readable medium containing machine executable instructions implementing a method of monitoring an electronic message at the point of generation is provided. The instructions include a set of instructions for receiving information from a user via an electronic interface for inclusion in an electronic message; a set of instructions for determining a desired degree of recordlessness for the electronic message; and a set of instructions for choosing an appropriate electronic messaging functionality for generating and/or transmitting the electronic message based on the desired degree of recordlessness.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates one exemplary implementation of a recordlessness monitoring system;

FIG. 2 illustrates another exemplary implementation of a recordlessness monitoring system;

FIG. 3 illustrates yet another exemplary implementation of a recordlessness monitoring system;

FIG. 4 illustrates one exemplary implementation of a messaging information input interface;

FIG. 5 illustrates one exemplary implementation of a notification interface;

FIG. 6 illustrates another exemplary implementation of a notification interface;

FIG. 7 illustrates another exemplary implementation of a messaging information input interface;

FIG. 8 illustrates yet another exemplary implementation of a messaging information input interface;

FIG. 9 illustrates yet another exemplary implementation of a notification interface;

FIG. 10 illustrates one exemplary method of recordlessness monitoring;

FIG. 11 illustrates another exemplary method of recordlessness monitoring;

FIG. 12 illustrates yet another exemplary method of recordlessness monitoring;

FIG. 13 illustrates one exemplary implementation of a recordless messaging system; and

FIG. 14 illustrates one exemplary implementation of a computing environment.

### DETAILED DESCRIPTION

In one embodiment, a computerized system and method of monitoring an electronic message at the point of generation is provided. Information is received for inclusion in an electronic message. A desired degree of recordlessness for the information is determined. Based on the desired degree of recordlessness, an appropriate electronic messaging functionality for generating and/or transmitting the electronic message is determined.

An electronic message may be generated and transmitted from a sender to one or more recipients using a variety of electronic messaging formats. Examples of such electronic messaging formats include, but are not limited to, electronic mail (“email”), instant message (“IM”), text message and recordless message (discussed further below). Each format may be implemented in a different way by a particular electronic messaging functionality (e.g., a messaging system or subsystem) such that varying degrees of records are kept of the contents and/or activity related to the electronic messaging. In one example, an electronic messaging system may be implemented such that a minimum amount of a record and traceability of an electronic message is retained at a senders system once the message is sent, on any intermediary systems, and on a recipients system upon reading the electronic message a predetermined amount of time. Such a system would have a high degree of recordlessness. A recordful electronic messaging system and format would leave a considerable record and traceability of an electronic message. For example, traditional email systems would be considered fairly recordful, with a low degree or recordlessness. A recordful system typically generates an electronic message that has a level of permanence outside of transit between the sender and the recipient. For example, a recordful electronic message may leave a trace of its contents cached on a sender's computing system, may remain in the electronic messaging system's storage until manually deleted by a recipient, and/or may leave a trace of its contents cached on a recipient's computing system. In another example, an example of a more recordful electronic message may be input, saved, transmitted, and/or displayed such that its message contents, message header, and/or one or more file attachments are input, saved, transmitted, and/or displayed together.

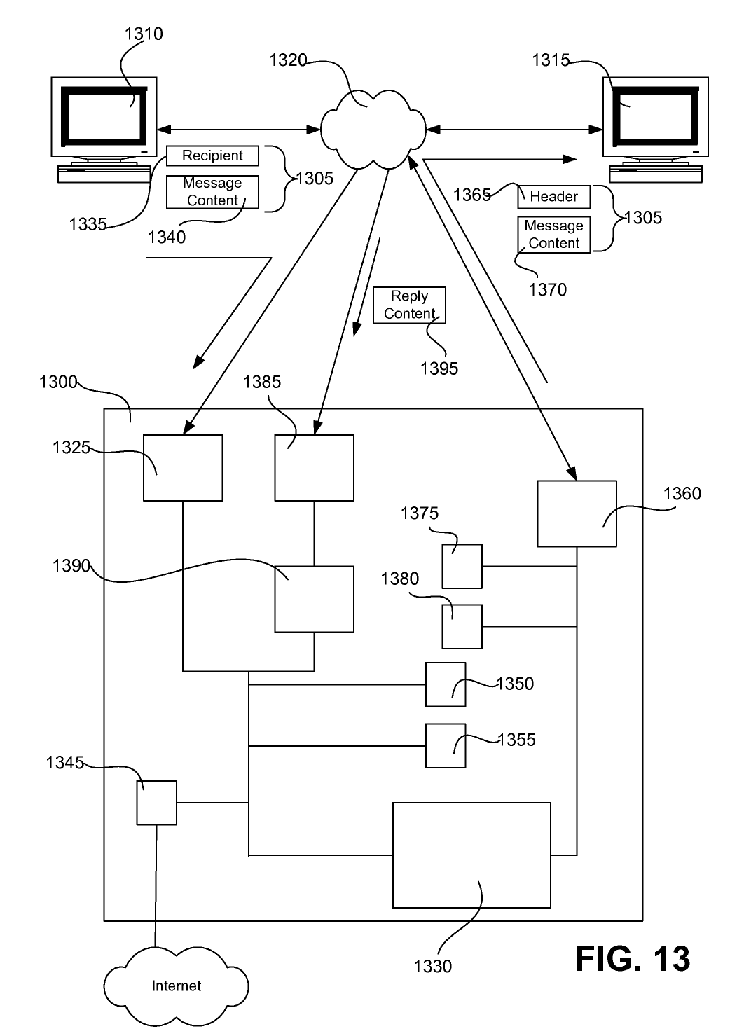

Greater degrees of recordlessness of an electronic message may be achieved by decreasing the traceability and/or reproducibility of an electronic message (e.g., after a predetermined time). In one example, the traceability and/or reproducibility of an electronic message may be decreased by inputting header information and content information on separate screens. In one aspect, separation of header information and content information may decrease the ability for surreptitious activity (e.g., logging, message interception, etc.) from linking a particular message content (and possibly one or more message attachments) with its header information. Other examples of reduction in the traceability and/or reproducibility of an electronic message include, but are not limited to, separating header information and message content information during transmission, storage, and/or display; blocking message content from being cached on a sender's system after it is transmitted therefrom; blocking message content from being cached on a recipient's system after it has been viewed; deleting (e.g., permanently deleting using a protocol sufficient to minimize recouping data once it is deleted) an electronic message from an electronic messaging system upon it being viewed by a recipient a predetermined amount of times (e.g., viewed a single time); deleting an electronic message from an electronic messaging system after a predetermined amount of time; and any combinations thereof. Exemplary messaging functionalities having decreased traceability and/or reproducibility (e.g., a high degree of recordlessness) are discussed further below with respect to FIG. 13.

As discussed above, an electronic message may be generated and transmitted using one or more of a variety of electronic messaging formats. Different electronic messaging functionalities typically utilize different messaging formats which may have different degrees of recordlessness. Example electronic messaging functionalities include, but are not limited to, a conventional email system (e.g., SMTP systems, POP systems, MS OUTLOOK, LOTUS NOTES, YAHOO MAIL, AMERICA ONLINE MAIL), an instant messaging system (e.g., YAHOO INSTANT MESSENGER), a voice-to-text system, a text-to-voice system, a recordless messaging system (e.g., VAPORSTREAM), and any combinations thereof. Typically, a conventional email system, such as MS OUTLOOK, operating under typical conditions will have a low degree of recordlessness. A recordless messaging system is an example of an electronic messaging system with a high degree of recordlessness. One example of such a system is the VAPORSTREAM messaging system available at http://www.vaporstream.com.

An electronic message may include (e.g., as part of a message content) any of a wide variety of information including, but not limited to, text, an image, video (e.g., single play video utilizing an application, such as MACROMEDIA FLASH), binary, tabular data (e.g., a spreadsheet), rich text including variable font color, tables, etc.), audio (e.g., single play audio utilizing an application, such as MACROMEDIA FLASH), other types of data, and any combinations thereof. In one example, a message content of an electronic message may include embedded information. In another example, a message content of an electronic message may include an attached and/or linked file. In such an example with an attached and/or linked file, the attached and/or linked file may be automatically deleted from the messaging system after being viewed by a recipient. In one exemplary aspect, a message content/body component is typically the substantive information that a sender wishes to convey to a recipient and it does not include information that in itself identifies the message sender, recipient, location of the electronic message, or time/date associated with the electronic message. An electronic message also typically includes a header component that includes identifying information such as, for example, an identifier of the sender, and identifier of one or more recipients, a date/time associated with the electronic message (e.g., of creation, delivery, etc.), a display name representing a sender of the electronic message, and any combinations thereof. In one example, a message subject may be treated as header information.

In one exemplary aspect, the degree of recordlessness used to generate and send an electronic message may depend on the information that the electronic message will include or already includes. The content of information for an electronic message may require that a higher degree of record-keeping take place. For example, in a highly regulated industry, such as the financial industry in the United States, there may be legal requirements to keep records of certain communications for certain amounts of time. In other situations, there may be less need to retain a record of a communication and possibly even a great desire to eliminate any record of a communication. In such situations, use of an electronic messaging system that has a higher degree of recordlessness may be desired.

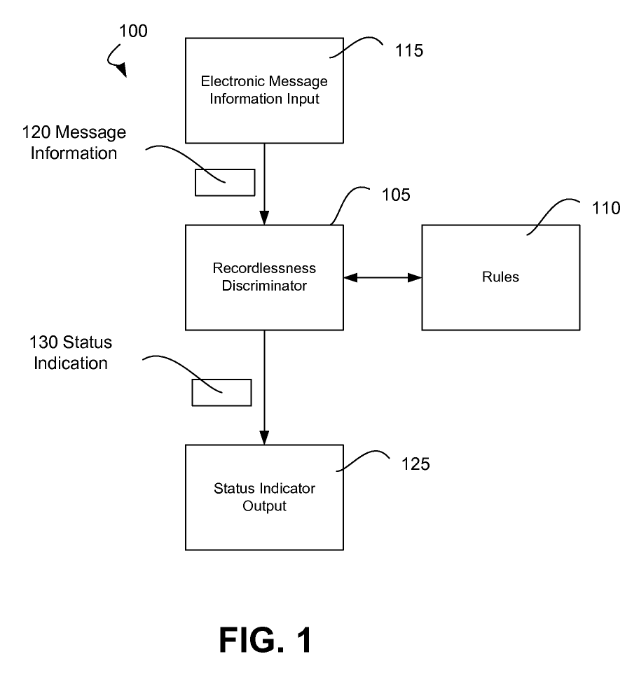

FIG. 1 illustrates one exemplary implementation of a system for determining a desired degree of recordlessness for electronic message information for an electronic message. System 100 includes a recordless discriminator 105. Recordless discriminator 105 is in communication with rules 110 and an electronic message information input 115 (e.g., an electronic user interface). Recordless discriminator 105 monitors messaging information 120 received and utilizes rules 110 to determine a desired degree of recordlessness for message information 120. Recordless discriminator 105 may include software and hardware necessary to apply rules 110 to message information 120. In one example, recordless discriminator 105 includes machine-executable instructions for applying rules 110 to message information 120. Message information, such as message information 120, may include all or a portion of any information that may be compiled in an electronic message from a sender to one or more recipients. Examples of message information include, but are not limited to, a message content (e.g., message body), a message header, a file attachment (e.g., a MS Word document, an Adobe PDF document), a message subject, and any combinations thereof.

Message information, such as message information 120, may be related to any electronic message. In one example, a message information (e.g., message information 120) may be part or all of an electronic message that is to be analyzed by a recordless discriminator at the time the electronic message is being compiled (e.g., as an electronic message is being typed into a messaging interface, as a file attachment is being attached to a message contents, and any combinations thereof). In another example, message information (e.g., message information 120) may be part or all of an electronic message that has been compiled and is ready for transmission from a sender's computing system (e.g., an electronic message to be analyzed by a recordless discriminator after a send command/button is executed by a sender). In yet another example, message information (e.g., message information 120) may relate to an electronic message that has previously been generated and/or sent (e.g., a stored electronic message). One implementation of such an example may include use of recordless discriminator 105 to determine a desired degree of recordlessness for each of a plurality of previously transmitted electronic messages stored in a database. In one example, the resultant data of desired recordlessness may be used to analyze the previously transmitted electronic messages to determine a historical record of required recordlessness.

A set of rules for determining a degree of recordlessness desired for a particular information, such as rules 110, may include instructions (e.g., a machine executable instruction) for analyzing a message information to determine a desired level of recordlessness. An example of instructions that may be included in a set of rules include, but are not limited to, an instruction for determining a frequency of occurrence of one or more data elements, an instruction for determining a pattern in the message information, an instruction for identifying one or more data elements in a message information that would lend it to have an electronic message including it therein be more likely to be desired to have a particular degree of recordlessness, and any combinations thereof. In one example, a set of rules, such as rules 110, may include instructions for determining the frequency of occurrence of one or more terms or data values in a message information. In such an example, the existence of one or more predetermined terms or data values may indicate that an electronic message that includes such information should be created with a low degree of recordlessness (i.e., high degree of recordfullness). In another example, the frequency of one or more predetermined terms or data values may indicate that an electronic message that includes such information should be created with a high degree of recordlessness (i.e., with little reproducibility and/or traceability). Algorithms for determining the frequency of data elements are known to those of ordinary skill. A set of rules, such as rules 110, in another example, may include instructions that heuristically analyze a message information. Rules for determining desired recordlessness of a message information may vary depending on the implementation. For example, rules in a regulated industry may be influenced by the particular regulations for that industry and may have instructions designed to implement the regulations. In another example, rules in an environment that demands high levels of confidentiality (e.g., a national security implementation) may be designed to favor a high degree of recordlessness for all but a few situations. These situations may be designed into the rules for detecting those electronic messages that are desired to have a more recordfull character.

Rules, such as rules 110, may exist in a variety of formats. Example formats for rules 110 include, but are not limited to, a data table; instructions in a database; instructions in XML format, machine code (e.g., C++ compiled), byte code (e.g., JAVA, .NET), interpretive code (e.g., JAVASCRIPT); and any combinations thereof. Rules, such as rules 110, may be updateable. In one example, rules may be manually updated (e.g., based on a change in a legal regulation, based on a workplace environment change, etc.). In another example, recordlessness discriminator 105 may include (and/or be associated with) instructions for iteratively monitoring application of rules 110 to message information and learning one or more patterns from the implementation of the resultant determination of desired degree of recordlessness (an example of a learning process is described in more detail below).

System 100 includes a status indicator output 125. Recordlessness discriminator 105 may output a status indication 130 of a determination of desired recordlessness for a given message information, such as message information 120, via status indicator output 125. In one example, a status indication (e.g., status indication 130) may include an indication that a message information has a particular desired degree of recordlessness. In another example, a status indication (e.g., status indication 130) may include an indication that a message information has a plurality of desired degrees of recordlessness (e.g., in a situation where more than one level of recordlessness may be acceptable, in a situation where a range of levels of recordlessness may be acceptable). In yet another example, a status indication (e.g., status indication 130) may include an indication that a message information may have any degree of recordlessness (e.g., a don't care indication). Status indicator output 125 is shown as a separate component from recordless discriminator 105. It is contemplated that the functionality of status indicator output 125 may be incorporated in recordless discriminator 105. In one such example, the output of a status indicator may be an internal logic progression used for determining an appropriate electronic messaging functionality for generating and transmitting an electronic message consistent with a desired degree of recordlessness.

System 100 may exist in a variety of computing environments. In one example, system 100 may be an independent system used to determine a desired degree of recordlessness for a message information (e.g., a system that generates data of recordlessness for existing electronic message data). In another example, system 100 may be used in connection with a single electronic messaging system (e.g., a system that utilizes status indication 130 to generate a notice to a user of the electronic messaging system of one or more desired degrees of recordlessness for an electronic message). In yet another example, system 100 may be used in connection with a plurality of electronic messaging systems that each may have a different degree of recordlessness (e.g., a traditional email system, an instant message system, and a recordless system such as one of the recordless systems described with respect to FIG. 13). In one such example, system 100 may utilize status indication 130 to generate a notice to a user of a desired electronic messaging system of the plurality of systems for sending the electronic message at the desired degree of recordlessness. In another such example, system 100 may utilize status indication 130 to automatically route an electronic message to an appropriate one of the plurality of electronic messaging systems based on the desired degree of recordlessness. In still another example, system 100 may be part of a messaging system that is capable of generating and transmitting electronic messages at different degrees of recordlessness (e.g., based on status indication 130).

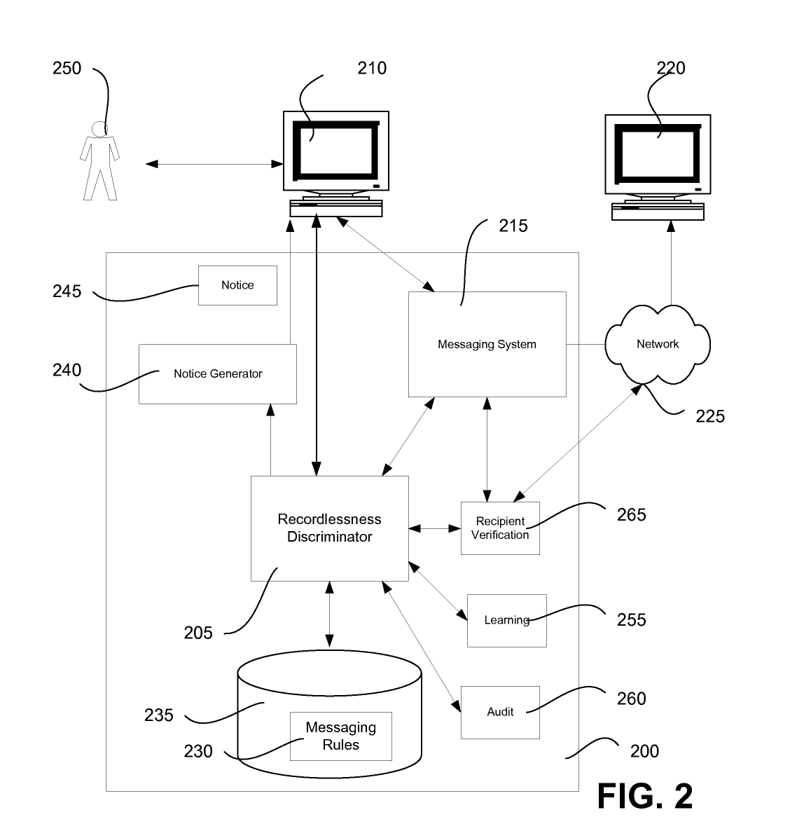

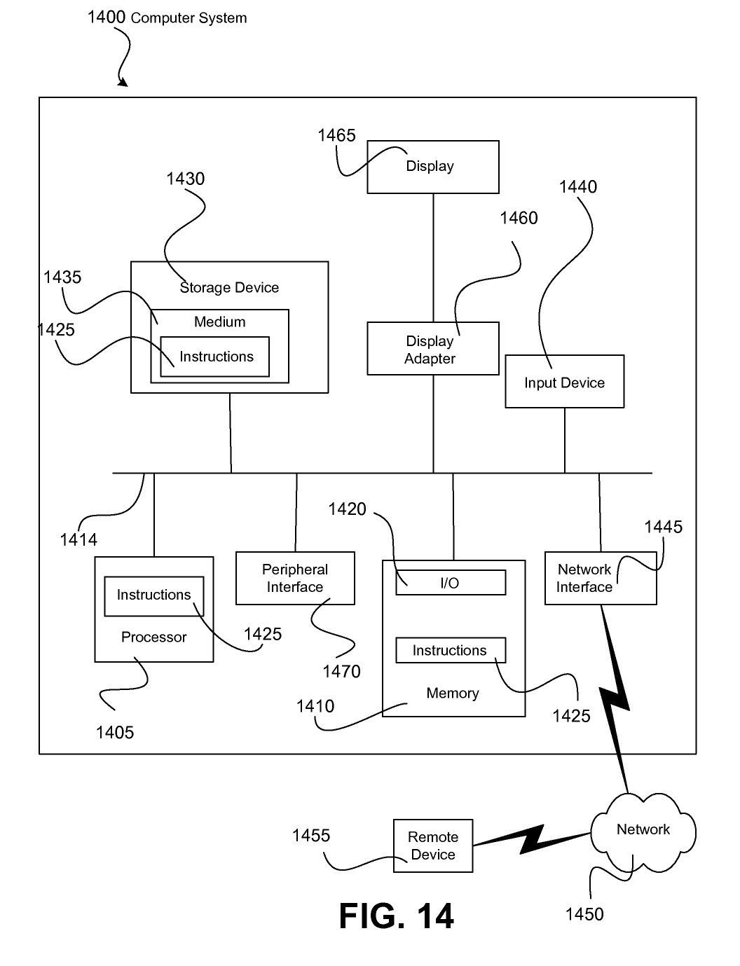

FIG. 2 illustrates another implementation of a system 200. System 200 includes a recordlessness discriminator 205 in communication with a sending input device 210. Recordlessness discriminator 205 may have similar aspects as recordlessness discriminator 105. Additional aspects of recordlessness discriminator 205 are discussed herein. Sending input device 210 may be any device capable of receiving information for inclusion in an electronic message. In one example, sending input device 210 may include a computing device. Exemplary computing devices and network environments are described below with respect to FIG. 14. System 200 also includes an electronic messaging system 215. Electronic messaging system 215 may include any electronic messaging functionality capable of transmitting an electronic message to one or more recipient systems 220. Examples of an electronic messaging system/functionality are discussed above. In one example, a recipient system, such as recipient system 220 may include a computing device. Transmission of an electronic message may occur via one or more networks 225. A network, such as network 225 may include, but is not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 225, may employ a wired and/or a wireless mode of communication.

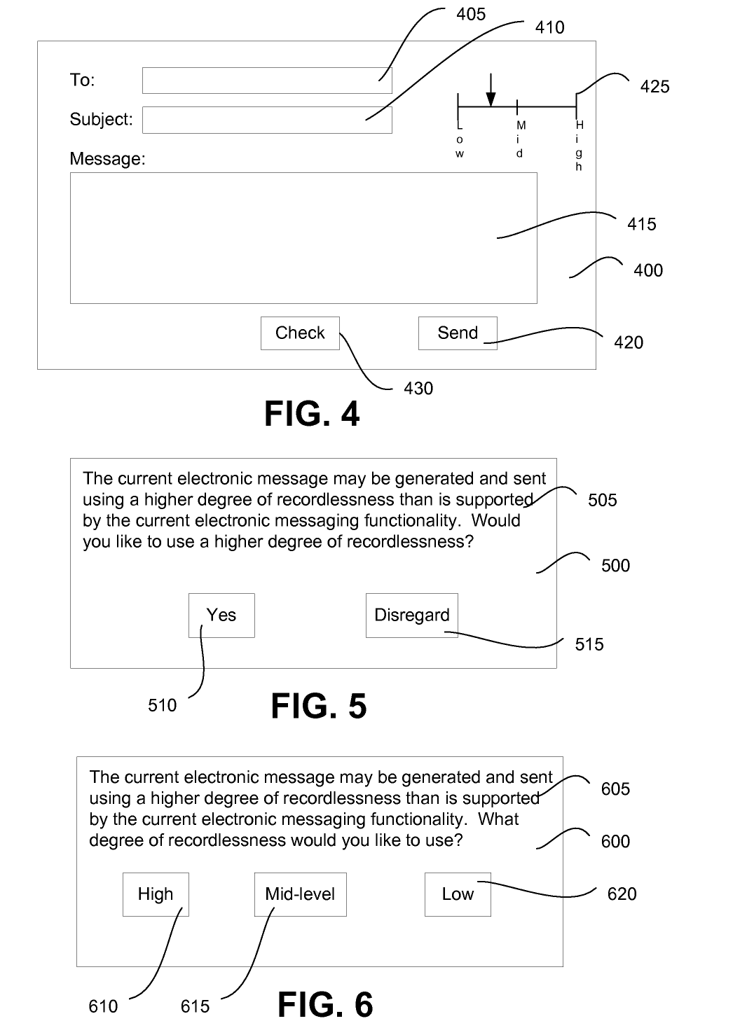

Recordlessness discriminator 205 is in communication with rules 230. Rules 230 reside in a database 235. A database, such as database 235, may be any data structure that can include instruction, such as rules 230. Examples of an appropriate data structure include, but are not limited to, a software data store, a hardware data store, a machine executable file, and any combinations thereof. Rules 230 is illustrated as being separate from recordless discriminator 205. In one alternative example, rules 230 may be included in recordlessness discriminator 205. Rules 230 include instructions for determining a degree of recordlessness for one or more message information received by sending input device 210. Rules for determining a degree of recordlessness are discussed above with respect to FIG. 1. In one example, one or more message information may be input to sending input device 210 via an electronic interface of sending input device 210. Example interfaces include, but are not limited to, an electronic data input interface, a graphical user interface, a command line user interface, and any combinations thereof. In one example, an interface may be an interface of associated with recordless discriminator 205. In such an example, messaging information entered therein may be monitored by recordless discriminator 205 and if appropriate based on the desired degree of recordlessness passed to a messaging system, such as messaging system 215 for transmission of an electronic message. In another example, an interface may be an interface of electronic messaging system 215. In one such example, messaging information entered therein may be monitored by recordless discriminator 205 prior to messaging system 215 generating and/or transmitting an electronic message based thereon. Recordless discriminator 205 may control and/or limit the generation and/or transmission of the electronic message by messaging system 215 based on the desired degree of recordlessness as described below. Exemplary interfaces are illustrated below with respect to FIGS. 4 to 9.

Recordlessness discriminator 205 compares data of a message information received by sending input device 210 with rules 230 to determine one or more desired degrees of recordlessness for the message information. Determination of the one or more desired degrees of recordlessness may occur at a variety of times. In one example, recordlessness discriminator 205 may monitor the input of a message information to sending input device 210 as the information is being input (e.g. while the information is being typed, uploaded, downloaded, attached, etc. to sending input device 210, such as through the interface). In another example, recordlessness discriminator 205 may compare a message information at the completion of input to sending input device 210 (e.g., at the receipt of a send command to an interface of sending input device 210). In yet another example, an interface of sending input device 210 may include an interactive element (e.g., a graphical user interface button) to allow a user to initiate a comparison of all or part of a message information with rules 230.

In one implementation, recordless discriminator 205 may output an indication of the one or more desired degrees of recordlessness to electronic messaging system 215 for use in determining the degree of recordlessness of an electronic message generated from the message information. In one example, electronic messaging system 215 may be configured to generate an electronic message at only one degree of recordlessness. In another example, electronic messaging system 215 may be configured to generate and/or transmit an electronic message at any one of a plurality of degrees of recordlessness. In such an example, electronic messaging system 215 may, for example, utilize a degree of recordlessness of electronic messaging system 215 that matches the desired degree of recordlessness most closely. It is contemplated that recordless discriminator 205 may be associated with electronic messaging system 215 such that recordless discriminator 205 determines the appropriateness of electronic messaging system 215 for a desired degree of recordlessness.

In another implementation system 230 may also include an optional notice generator 240 in communication with recordless discriminator 205 for outputting a notice 245 of the one or more desired degrees of recordlessness. Notice generator 240 may be in communication with sending input device 210 and include (and/or be associated with) necessary software and/or hardware for displaying notice 245 to a user 250 of sending input device 210 (in such an example, sending input device 210 may be configured also as an output device). In one example, notice 245 may include an indication that electronic messaging system 215 is capable of generating an electronic message that meets the desired degree of recordlessness of the message information. In another example, notice 245 may include an indication that electronic messaging system 215 is not capable of generating an electronic message that meets the desired degree of recordlessness of the message information and/or an indication that a different electronic messaging system should be utilized (e.g., an electronic messaging system with a higher or lower degree of recordlessness than electronic messaging system 215). In yet another example, notice 245 may include an interactive element that allows user 250 to provide an instruction to electronic messaging system 215. The instruction to electronic messaging system 215 may include a variety of instructions related to the generation and/or transmission of an electronic message compiled from the message information. In one example, the instruction to electronic messaging system 215 may include an indication to generate and/or send an electronic message including the message information (e.g., utilizing a specified degree of recordlessness that most closely matches the desired degree of recordlessness). In another example, the instruction to electronic messaging system 215 may include an indication to not generate and/or send an electronic message including the message information. In yet another example, user 250 may choose to ignore a recommendation of a desired degree of recordlessness given by notice 245. In a further example, any combination of the above examples may be combined in a single notice.

Recordlessness discriminator 205 and the other components of system 200 are shown as separate components. In an alternative example, one or more of recordlessness discriminator 205, electronic messaging system 215, rules 230, and notice generator 240 may be included as part of any of the other components of system 200. In another example, one or more of recordlessness discriminator 205, electronic messaging system 215, rules 230, and notice generator 240 may be included as part of sending input device 210. System 200 is illustrated as being in direct communication with sending input device 210. In an alternative example, one or more of the components of system 200 may be included and/or associated with one or more separate computing device in close proximity or remote from sending input device 210. The one or more separate computing devices may be interconnected (e.g., with sending input device 210) via one or more networks.

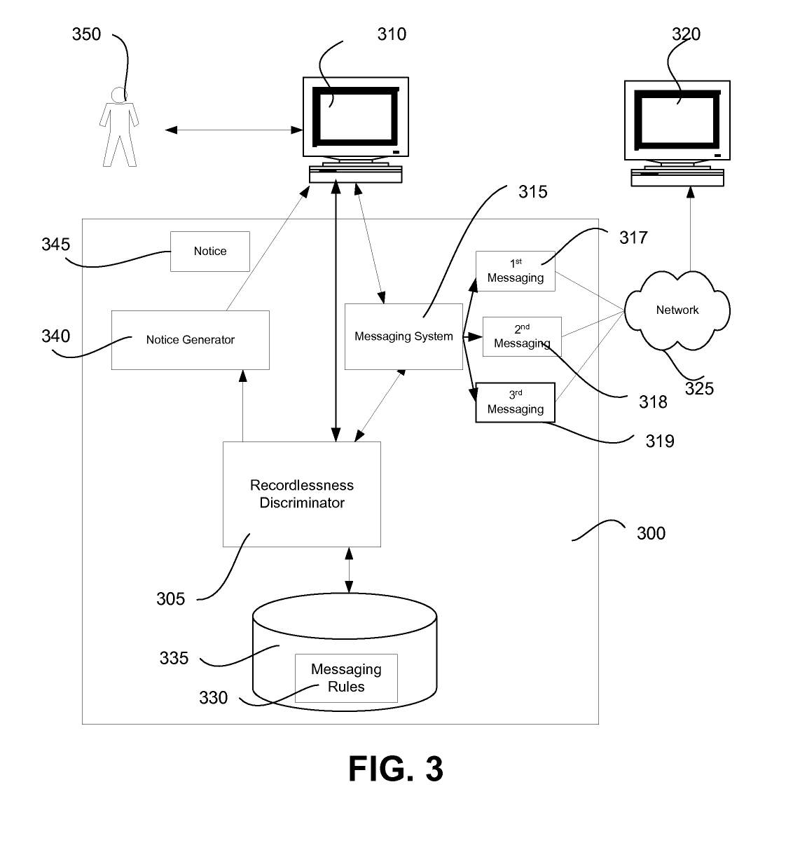

FIG. 3 illustrates yet another implementation of a system 300. System 300 includes, and has associated therewith, various components that are similar to those described above with respect to system 200. These components have similar characteristics and functions as described above, except where described as different below.

System 300 includes a recordlessness discriminator 305 in communication with a sender input device 310. System 300 also includes an electronic messaging system 315 in communication with recordlessness discriminator 305 and sender input device 310. Messaging system 315 is illustrated as being in communication with a first messaging component 317, a second messaging component 318, and a third messaging component 319. In an alternative implementation first, second, and third messaging components 317, 318, and 319 are part of messaging system 315 (e.g., electronic messaging system 315 has equivalent functionality as a plurality of differing messaging components, such as being able to generate and/or transmit an electronic message at one of a plurality of types, for example, a recordless message or a traditional email message). In an example where messaging components 317, 318, and 319 are separate messaging systems, messaging system 315 may be an interface between each of the multiple messaging components 317, 318, and 319 and other components of system 300. System 300 is shown with three messaging components 317, 318, 319. It should be noted that system 300 may include any number of messaging components (e.g, 1, 2, 3, 4, etc.) for generating and/or transmitting an electronic message compiled from one or more message information input to sender input device 310 to a recipient system 320 via a network 325. In one example, each of first, second, and third messaging components 317, 318, 319 include components of an electronic messaging system (e.g., machine-executable instructions for generating and transmitting electronic messages) configured at a different degree of recordlessness than the others.

Recordlessness discriminator 305 compares a message information input to sender input device 310 with rules 330 stored in database 335. A message information may be input to sender input device utilizing an interface (as discussed above with respect to sender input device 210 of FIG. 2). In an alternate example, each of first, second, and third messaging components 317, 318, 319 may include individual interfaces for inputting a message information. In another example, an interface may be a common interface shared by first, second, and third messaging components. In yet another example, an interface may be an interface having the highest degree of recordlessness represented by system 300 (e.g., an interface of the level of recordlessness of the first, second, and third messaging components having the highest degree of recordlessness).

In one example, rules 330 include instructions for determining a degree of recordlessness for any message information input to sender input device 310. In another example, rules 330 include different instructions for determining a degree of recordlessness depending on which of first second, and third messaging components 317, 318, 319 are utilized to initiate input of a message information.

Recordless discriminator 305 may output an indication of a desired degree of recordlessness to electronic messaging system 315. In one example, electronic messaging system 315 may utilize the indication of desired degree of recordlessness to determine which of messaging components 317, 318, 319 to utilize for generating and/or transmitting an electronic message compiled from the message information. In another example, electronic messaging system 315 may utilize the indication of desired degree of recordlessness to automatically generate and/or transmit an electronic message compiled from the message information using one of messaging components 317, 318, 319 having a degree of recordlessness that matches the desired degree of recordlessness. In yet another example, electronic messaging system 315 may utilize the indication of desired degree of recordlessness to allow generation and/or transmission of an electronic message compiled from the message information using only those messaging components of messaging components 317, 318, 319 that have a degree of recordlessness that matches the desired degree of recordlessness. In still another example, electronic messaging system 315 may utilize the indication of desired degree of recordlessness to block generation and/or transmission of an electronic message compiled from the message information using those messaging components of messaging components 317, 318, 319 that do not have a degree of recordlessness that matches the desired degree of recordlessness. It is contemplated that recordlessness discriminator 305 may be associated with messaging system 315 (e.g., utilizing a desired degree of recordlessness internally to recordlessness discriminator 305, connected with messaging system 315, part of messaging system 315) in such a way to allow recordlessness discriminator 305 to utilize a desired degree of recordlessness to manage the generation and transmission of an electronic message by messaging system 315 (and/or subsystems 317, 318, 319) consistent with the methodologies and embodiments disclosed herein.

In another implementation, system 300 may also include an optional notice generator 340 for generating a notice 345 including the indication of desired recordlessness from recordlessness discriminator 305. As discussed above with respect to notice 245, notice 345 may include a variety of indicators and/or interactive elements. In another example, notice 345 may include an indication of those messaging components of messaging components 317, 318, 319 that have a degree of recordlessness that matches the desired degree of recordlessness; an indication of those messaging components of messaging components 317, 318, 319 that do not have a degree of recordlessness that matches the desired degree of recordlessness; an interactive element to allow a user 350 to select an instruct an appropriate messaging component from messaging components 317, 318, 319 to generate and/or transmit an electronic message including the message information; and any combinations thereof. In certain situations, rules 330 may instruct recordlessness discriminator 305 to forego a notice to a user and to instruct a particular messaging component to automatically generate an electronic message.

A degree of recordlessness associated with a particular electronic messaging system and/or format (e.g., associated with each of messaging components 317, 318, 319) may be determined relative to other electronic messaging systems and/or formats. For example, each electronic messaging system and/or format may be analyzed with respect to its characteristics, such as characteristics that reduce the reproducibility and/or traceability of an electronic message. Some of these characteristics are discussed above. In one exemplary comparison, a quantitative value may be given to an electronic messaging system and/or format that is related to the number and degree of implementation of characteristics that reduce reproducibility and/or traceability. Such quantitative values for a plurality of electronic messaging systems may be compared to determine a relative ranking of recordlessness of electronic messaging systems. In another example, qualitative comparison may be utilized to rank the relative recordlessness of electronic messaging systems. For example, messaging component 317 may have characteristics that are known to significantly reduce reproducibility and/or traceability whereas messaging component 318 may have characteristics that are known to produce an easily accessible record of an electronic message generated and/or transmitted therewith.

In an alternative implementation, systems 100, 200, and/or 300 may include a learning module (such as the exemplary optional learning module shown in FIG. 2 as learning module 255) for monitoring choices made by a user, such as user 350, when presented with a recommendation based on a desired degree of recordlessness. Choices consistent with and/or choices against a recommendation may be used to modify the rules used to determine the desired degree of recordlessness. For example, if a user consistently chooses a particular electronic messaging system (e.g., one that was recommended, one that was not recommended, and/or one from a plurality of recommended systems), the rules may be updated to favor that particular electronic messaging system. In another example, the rules may be modified to skip generating a notice and automatically generate and/or transmit an electronic message with that particular electronic messaging system.

In another alternative implementation, systems 100, 200, and/or 300 may include an audit module (such as the exemplary optional audit module shown in FIG. 2 as audit module 260) for collecting data related to various components of the systems (e.g., recordlessness discriminator, notice generator, electronic messaging system, etc.). Example data may include, but is not limited to, data related to frequency of particular portions of a rule being applied to a message information, data related to frequency of occurrence of message information data element and/or term, data related to choices made from a notice displayed to a user, data related to frequency of use of a particular electronic messaging system, data related to automatedness of electronic messaging, and any combinations thereof. In one example, such data may be used for maintenance of the system, system administration, updating rules, producing reports (e.g., usage reports), determining accuracy of recommendations of desired degree of recordlessness, etc.

In yet another alternative implementation, systems 100, 200, and/or 300 may include a recipient verification module (such as the exemplary optional recipient verification module shown in FIG. 2 as recipient verification module 265). Recipient verification module 265 is in communication with recordless discriminator 205. Recipient verification module 265 may also be in communication with messaging system 215 and/or a network, such as network 225. A recipient verification module is configured to provide communication with local and/or centralized components (e.g., via a public network, such as the Internet) of one or more of the electronic messaging functionalities available for generating and transmitting an electronic message based on information received from a user. A recipient verification module utilizes information received from a sending user that identifies one or more intended recipients to verify with the one or more available messaging systems (e.g., through publicly accessible gateway to user lists, through negotiated private access to user lists) that the one or more recipients have the ability to receive an electronic message via a particular messaging functionality. For example, a recipient verification module may request verification from a centralized server for a messaging system (e.g., an operator of a recordless messaging system that may require membership and/or specific hardware/software to receive electronic messages at the degree of recordlessness provided by the recordless messaging system) that the recipient user is capable of receiving a message at a particular level of recordlessness. A message monitor, such as recordless discriminator 205, may utilize information about a recipient to limit the available messaging functionalities for a particular electronic message. In one example, a sender may designate a recipient in an interface that has associated therewith three different electronic messaging functionalities that have varying degrees of recordlessness and recordless discriminator 205 may determine a desired degree of recordlessness that recommends the use of one of the three functionalities. In one such example, where the recipient may not have the ability to receive an electronic message generated and transmitted using the recommended messaging functionality (as verified by recipient verification module 265), recordless discriminator 205 may eliminate that messaging functionality as an available messaging functionality for that electronic message and/or for that recipient.

It should be noted that an electronic message may include various portions (e.g., a message body/content, a file attachment, a message header) that may be monitored for a desired degree of recordlessness in various combinations or each separately. In one example, the portion with the highest degree of desired recordlessness will dictate the desired degree of recordlessness of all portions of the electronic message. In another example, the portion with the lowest degree of desired recordlessness will dictate the overall desired degree of recordlessness for all portions of the electronic message. In still another example, only one component of an electronic message is monitored (e.g., message body/content, attachment(s), or message header). In yet another example, two or more components of an electronic message are monitored.

FIG. 4 illustrates one exemplary implementation of an interface 400 for receiving message information. Interface 400 includes a recipient portion 405 for input of one or more electronic addresses of a recipient of the electronic message. Interface 400 also includes an optional subject portion 410 for input of descriptive information of the message. A message body/content portion 415 provides a user with the ability to input content information for the electronic message. Interface 400 includes a send button 420 which can be utilized by a user to instruct interface 400 to transmit the electronic message. A message monitor (e.g., recordlessness discriminator 105 of FIG. 1) may be in communication with interface 400 for monitoring information received via the interface.

As discussed above, a determination of a desired degree of recordlessness for an electronic message received via an interface, such as interface 400, may occur at one or more times relative to the entry of the message information. In one example, a determination of a desired degree of recordlessness may be made on the fly as it is entered (e.g., as it is typed into the interface by a user). In one such example, interface 400 may include an optional desired degree of recordlessness indicator 425. Indicator 425 may be in communication with a notice generator (e.g., notice generator 240, 340) for receiving information indicating a desired degree of recordlessness from a message monitor. Any of a variety of indicators that can provide an indication of a desired degree of recordlessness may be utilized. Examples of an indicator include, but are not limited to, a text indicator, a dial indicator, a graphic indicator, a slide indicator, and any combinations thereof. Interface 400 is shown with an example of a slide indicator for indicator 425. In another example of on-the-fly notification of the desired degree of recordlessness, a notification (e.g., a pop-up window, graphical/text box) may be provided when a certain threshold of desired degree of recordlessness is determined by a message monitor (e.g., when interface 400 is part of a messaging functionality, such as MS OUTLOOK, which is configured with a low degree of recordlessness a notification may be provided upon a determination that a desired degree of recordlessness is higher than the degree of recordlessness provided by the messaging functionality of interface 400).

In another example, a desired degree of recordlessness may be made upon a user actuating send button 420 to transmit the electronic message to the one or more recipients. In one such example, an appropriate electronic messaging functionality associated with interface 400 that most closely matches the desired degree of recordlessness may automatically be utilized to generate and transmit the electronic message. In another such example, an indication that one or more electronic messaging functionalities associated with interface 400 do not match the desired degree of recordlessness may be provided to a user of via interface 400 and/or another associated interface.

Interface 400 may also include an optional recordlessness check button 430. In one exemplary aspect, recordlessness check button 430 may be utilized by a user of interface 400 to manually instruct a message monitor to check one or more of the components of the electronic message for a desired degree of recordlessness at any time during the composition of the electronic message. Selection of an appropriate electronic messaging functionality and/or a determination of the inappropriateness of a particular messaging functionality may be made from the determined desired degree of recordlessness.

Notification of information related to the desired degree of recordlessness, appropriateness of one or more electronic messaging functionalities, options for generation and/or transmission of an electronic message, and/or interactivity with selection of one or more appropriate messaging functionalities for generation and/or transmission of an electronic message may be provided to a user via a variety of electronic interfaces. FIG. 5 illustrates one exemplary electronic notification interface 500. Interface 500 includes a textual portion 505 including a notification that an electronic message (e.g., a message including messaging information received via interface 400) has a desired degree of recordlessness that allows for use of an electronic messaging functionality that has a higher degree of recordlessness than the functionality currently selected for use. Textual portion 505 prompts a user for instruction related to use of a higher degree of recordlessness in the generation and transmission of the electronic message. Interface 500 also includes an affirmative button 510 configured to allow the user to instruct a message monitor (e.g., recordless discriminator 105) to utilize an electronic messaging functionality that has a higher degree of recordlessness than the currently selected functionality (e.g., to use a vapor messaging system over a conventional recordfull email system).

Interface 500 also includes a disregard button 515 configured to allow the user to instruct a message monitor to disregard the recommendation for using a higher degree of recordlessness and to continue with the selected messaging functionality. In another example, a notification such as interface 500 may omit any option for a user to disregard a recommendation (e.g., not have disregard button 515) and force the user to follow a recommendation based on a desired degree of recordlessness. A notification interface, such as interface 500, may also include an optional indication of the one or more messaging functionalities that are available and/or an indication of the actual degree of recordlessness of each of the messaging functionalities available for use in generating and/or transmitting an electronic message. Interface 500 provides for interactivity with a user. It is contemplated that a notification may not have interactivity with a user. In one such example, a notification interface may simply provide an indication related to the desired degree of recordlessness determined for messaging information received.

FIG. 6 illustrates another exemplary electronic notification interface 600. Interface 600 includes a textual portion 605 including a notification that an electronic message (e.g., a message including messaging information received via interface 400) has a desired degree of recordlessness that allows for use of an electronic messaging functionality that has a higher degree of recordlessness than the functionality currently selected for use. Textual portion 605 prompts a user for instruction related to selection of a messaging functionality for generation and transmission of the electronic message. Interface 600 includes a high button 610 configured to allow a user to instruct a message monitor to utilize a messaging functionality having a relatively high degree of recordlessness, a mid-level button 615 configured to allow a user to instruct a message monitor to utilize a messaging functionality having a relatively middle degree of recordlessness, and a low button 620 configured to allow a user to instruct a message monitor to utilize a messaging functionality having a relatively low degree of recordlessness.

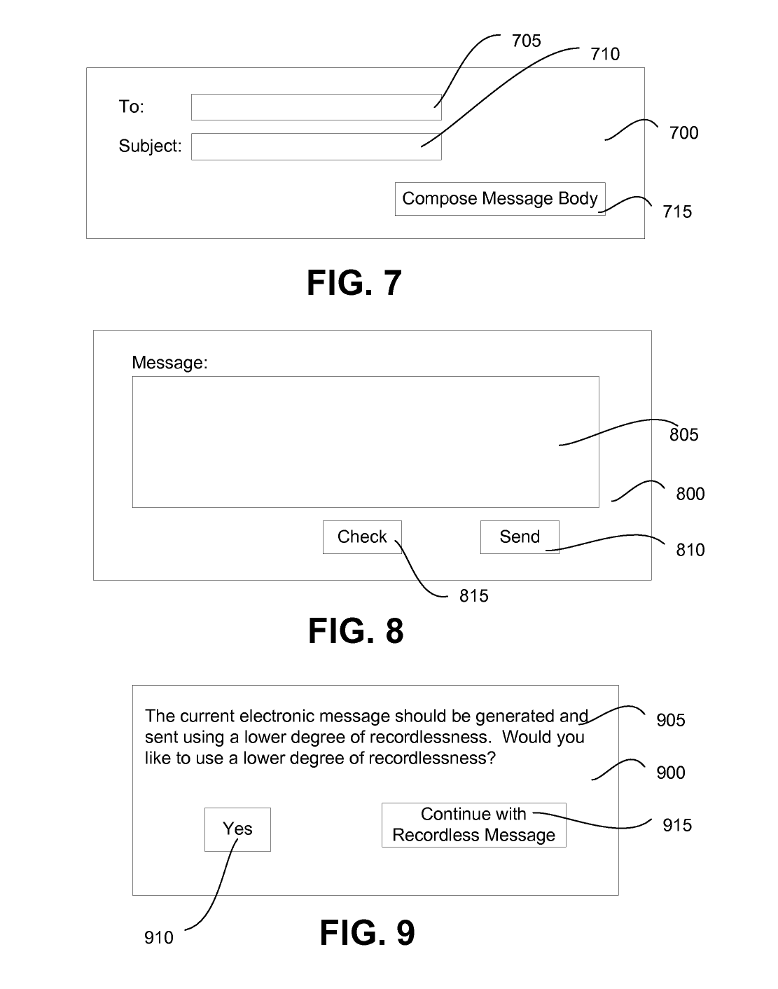

FIG. 7 illustrates another exemplary implementation of an interface 700 for receiving message information. Interface 700 includes a recipient portion 705 for entry of one or more recipient addresses and an optional subject portion 710 for entry of descriptive information about the electronic message. Interface 700 does not include a portion for entry of a message content/body. Interface 700 includes a compose message body button 715 that is configured to allow a user to prompt for a second interface to be provided that will allow entry of a message content/body.

FIG. 8 illustrates one exemplary implementation of an interface 800 for receiving message information related to a message content/body. In one example, interface 800 may be provided to a user upon the user selecting button 715 of interface 700. Interface 800 includes a message content portion 805 configured to allow a user to enter message information related to a message content/body of an electronic message. Interface 800 also includes a send button 810 and a recordless check button 815 configured to work similar to the corresponding buttons described above with respect to interface 400 of FIG. 4.

Interface 700 and interface 800 may be utilized together to allow a user to input messaging information in a manner that increases the recordlessness of the messaging information by separating header information and message content during input. One example of an electronic messaging functionality with a high degree of recordlessness that utilizes the separation of header information from message content during input, transmission, and/or display is discussed below with respect to FIG. 13. Interface 700 and/or interface 800 may optionally include one or more indicators of recordlessness (e.g., an indicator similar to the indicator discussed above with respect to interface 400 of FIG. 4).

FIG. 9 illustrates yet another example of an electronic notification interface 900. Interface 900 includes a textual portion 905 including a notification that an electronic message (e.g., a message including messaging information received via interfaces 700, 800) has a desired degree of recordlessness that would recommend the use of an electronic messaging functionality having a degree of recordlessness that is lower than the degree of recordlessness provided by the functionality currently selected for use. Textual portion 905 prompts a user for instruction related to selection of a messaging functionality for generation and transmission of the electronic message. Interface 900 includes a button 910 configured to allow the user to instruct a message monitor to generate and transmit the electronic message using an electronic messaging functionality having a lower degree of recordlessness (e.g., utilizing a conventional recordfull email system as opposed to a recordless messaging system, such as a system that separates header information from message body information). Interface 900 also includes a button 915 configured to allow the user to instruct a message monitor to generate and transmit the electronic message using an electronic messaging functionality having a high degree of recordlessness (e.g., utilizing a recordless messaging system despite the recommendation provided by textual information 905).

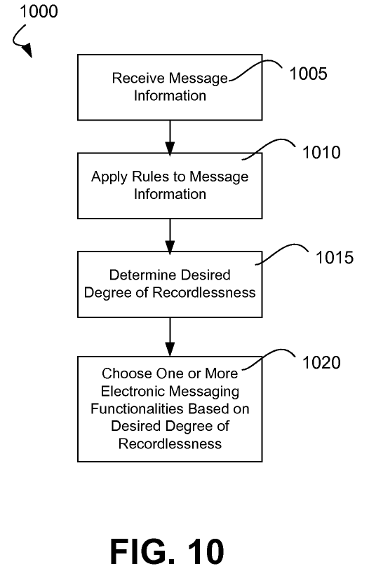

FIG. 10 illustrates one implementation of a method 1000. Method 1000 includes a step 1005 of receiving messaging information (e.g., via an input interface). Rules for determining a desired degree of recordlessness are applied at step 1010. A desired degree of recordlessness is determined at step 1015. At step 1020, one or more appropriate messaging functionalities for generating and transmitting an electronic message based on the messaging information is determined using the desired degree of recordlessness. As discussed above, a desired degree of recordlessness may be utilized in a variety of ways including, but not limited to, generation of a notice including the indicator of desired degree of recordlessness, blocking certain electronic messaging formats and/or systems from use in compiling an electronic message, allowing certain electronic messaging formats and/or systems for use in compiling an electronic message, automatically generating an electronic message utilizing a format and/or system having a matching degree of recordlessness to that of the desired degree of recordlessness, and any combinations thereof.

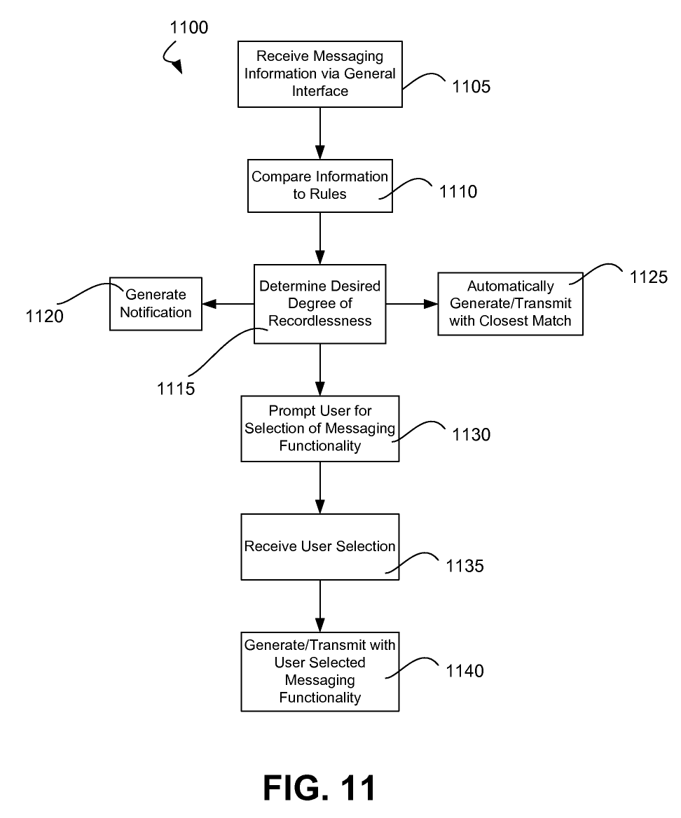

FIG. 11 illustrates another exemplary implementation of a method 1100 of monitoring and/or routing an electronic message. At step 1105, messaging information is received via a general interface that is configured to receive messaging information for use in an electronic message that may be generated and transmitted using one or more of a plurality of electronic messaging functionalities. In one example, the general interface may be associated with a messaging monitor (e.g., recordlessness discriminator 305 of FIG. 3). As discussed above, a variety of interfaces may be utilized. In one example, a general interface is configured to receive information in a manner consistent with the available messaging functionality that has the highest degree of recordlessness. In one such example, where available messaging functionalities include a conventional recordful email system (e.g., MS OUTLOOK) and a highly recordless messaging system (e.g., VAPORSTREAM), an interface compatible with the highly recordless messaging system is utilized for input for all available messaging functionalities. In one aspect, if a recordless messaging system includes the separation of header and message content information (e.g., during transmission and/or display to a recipient), use of an input interface that separates the input of the header and content information (although not necessary) may be advantageous in increasing overall recordfullness when necessary. In an alternative example, a more recordful interface may be utilized as a general interface. In such an example, steps may be taken by a message monitor (e.g., recordlessness discriminator 305) or other system component to generate a message from the input information (e.g., separation of header and content/body) prior to transmission. One example of an interface for use with a messaging functionality having a high degree of recordlessness was discussed above with respect to FIGS. 7 and 8.

At step 1110, one or more components (e.g., header, body, attachment) of the received information is compared to rules for determining a desired degree of recordlessness. As discussed above, this comparison may occur at a variety of times relative to the input of the information (e.g., during input, at manual prompt, upon receipt of a “send” instruction). At step 1115, a desired degree of recordlessness is determined. At optional step 1120, a notification of the desired degree of recordlessness may be generated. In one example, an indicator may be presented to a user with information based on the desired degree of recordlessness (e.g., indicator 425 of interface 400).

In one embodiment, method 1100 includes step 1125. At step 1125, an electronic message is automatically generated and transmitted utilizing one or more of the available electronic messaging functionalities automatically selected based on a comparison of the desired degree of recordlessness with the actual degree of recordlessness of each of the messaging functionalities. In one example (referring again to FIG. 3), recordlessness discriminator 305 compares the desired degree of recordlessness with information (e.g., information stored in an associated database) related to the actual degree of recordlessness of messaging subsystems 317, 318, 319. Recordlessness discriminator 305 may automatically determine the appropriate messaging functionality (e.g., functionality 318), prepares the received messaging information (e.g., separates header and message body), and communicates the messaging information to messaging functionality 318 with instructions to generate and transmit and electronic message.

In another embodiment, method 1100 includes step 1130. At step 1130, a notification interface configured to prompt a user for manual selection of an electronic messaging functionality based on the desired degree of recordlessness. In one example, a notification interface includes a recommendation of an appropriate messaging functionality based on the desired degree of recordlessness. In such an example, the interface may include a prompt for user selection (e.g., of the recommended messaging functionality, of a different messaging functionality, and/or of no messaging functionality). In another example, a notification interface includes a request for selection of one or more of the available messaging functionalities by a user. At step 1135, a selection from a user is received. At step 1140, an electronic message is generated and transmitted with one or more electronic messaging functionalities selected by the user.

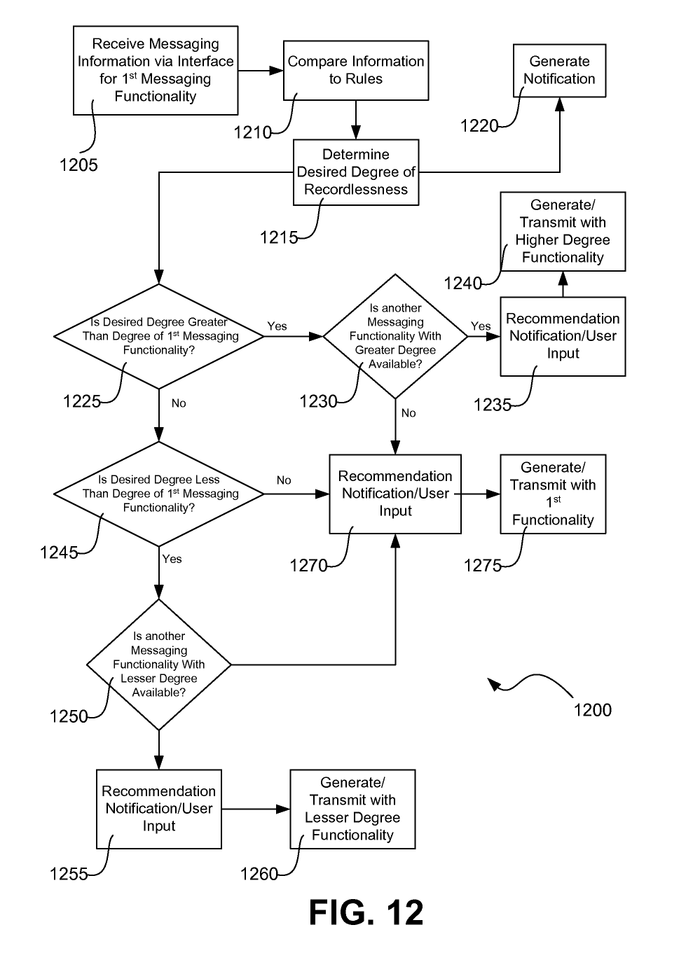

FIG. 12 illustrates another implementation of a method 1200 for monitoring and/or routing an electronic message. At step 1205, messaging information is received via an interface associated with a first messaging system of available messaging functionalities. In one example, a user may input messaging information into a conventional email interface (e.g., OUTLOOK interface) where the conventional email system is one of the available messaging functionalities. At step 1210, one or more components of the received information is compared to one or more rules for determining a degree of recordlessness for the information. In one example, a message monitor (e.g., recordlessness discriminator 305) is associated with the first messaging system such that the message monitor can monitor information input to the interface of the first messaging system prior to the generation and/or transmission of an electronic message based on the information. The message monitor compares the information to rules. As discussed above, this comparison may occur at a variety of times relative to the input of the information.

At step 1215, a desired degree of recordlessness for the information is determined (e.g., by message monitor 105, 205, 305). At optional step 1220, a notification based on the desired degree of recordlessness is generated (e.g., a notification interface as discussed above). At decision step 1225, it is determined if the desired degree of recordlessness is greater than the degree of recordlessness supported by the first messaging system. If yes, the method proceeds to step 1230. At step 1230, it is determined if another one of the available messaging functionalities supports a degree of recordlessness that corresponds to the desired degree of recordlessness (e.g., by message monitor 105, 205, 305). If yes, in one example, the method proceeds to optional step 1235. At step 1235, a recommendation notification (e.g., a notification interface) is provided to the user prompting the user to provide instructions for selecting a messaging functionality from available messaging functionalities. In one example, the user may select from one or more messaging functionalities that meet the desired degree of recordlessness, from one or more messaging functionalities that do not meet the desired degree of recordlessness, from a selection to not send a message, and any combinations thereof. A recommendation notification may also provide a user with information based on the desired degree of recordlessness (e.g., a recommendation for an appropriate messaging functionality). Also at optional step 1235, a user may provide a selection via an interactive interface to instruct the generation and transmission of an electronic message via a selected messaging functionality. Step 1240 includes the generation and transmission of an electronic message using a messaging functionality having a degree of recordlessness that corresponds with the desired degree of recordlessness. If the answer at step 1230 is yes and optional step 1235 is not included in method 1200, the method may proceed to step 1240 for automatic generation and transmission of an electronic message using one or more messaging functionalities having a degree of recordlessness that corresponds with the desired degree of recordlessness.

If the answer at step 1225 is no, method 1200 proceeds to step 1245. At step 1245, it is determined if the desired degree of recordlessness is lower than the degree of recordlessness supported by the first messaging system. If yes, the method proceeds to step 1250. At step 1250, it is determined if another one of the available messaging functionalities supports a degree of recordlessness that corresponds to the desired degree of recordlessness. If yes, in one example, the method proceeds to optional step 1255. At step 1255, a recommendation notification (e.g., as discussed above with respect to step 1235) is provided to the user prompting the user to provide instructions for selecting a messaging functionality from available messaging functionalities. Step 1260 includes the generation and transmission of an electronic message using a messaging functionality having a degree of recordlessness that corresponds with the desired degree of recordlessness (e.g., in this example, if the user selects such a messaging functionality). If the answer at step 1250 is yes and optional step 1255 is not included in method 1200, method 1200 may proceed to step 1260 for automatic generation and transmission of an electronic message using one or more messaging functionalities having a degree of recordlessness that corresponds with the desired degree of recordlessness.

If the answer at step 1245 is no, in one example, the method may proceed to optional step 1270. Optional step 1270 includes providing a recommendation notification (e.g., similar to that of steps 1235, 1255) and an opportunity for input from a user for selection of a messaging functionality. Depending on the selection by the user (e.g., if the user selects the first messaging system), method 1200 may proceed to step 1275. At step 1275, an electronic message is generated using the first messaging system. If the answer at step 1245 is no and optional step 1270 is not employed, method 1200 proceeds automatically to step 1275. At step 1275, an electronic message is automatically generated using the first messaging system.

In one example, if the answer at step 1230 is no, method 1200 proceeds to step 1270. In another example, if the answer at step 1230 is no, method 1200 proceeds directly and automatically to step 1275.

In one example, if the answer at step 1250 is no, method 1200 proceeds to step 1270. In another example, if the answer at step 1250 is no, method 1200 proceeds directly and automatically to step 1275.

FIGS. 10 to 12 illustrate exemplary implementations of methods according to the present disclosure. Variations of these methods will be clear to one or ordinary skill from the methodologies and aspects discussed herein. For example, it is contemplated that various aspects and/or methodologies from one implementation of a system and/or method discussed above may be interchangeable and/or combinable with another implementation.

In one exemplary embodiment, it is contemplated that a user selection prompt (e.g., in a notification interface) for selection of one or more messaging functionalities may include a choice of not sending a message at all. For example, a user may desire to forego generation and transmission of an electronic message when presented with information related to the desired degree of recordlessness.

In another exemplary embodiment, it is contemplated that a system and/or method as disclosed herein (e.g., one that automatedly transmits an electronic message based on a desired degree of recordlessness, one that prompts a user for selection of an electronic message functionality) may be configured to not allow an electronic message to be generated and/or transmitted if the desired degree of recordlessness is not met by one of the available messaging functionalities. In one example, (e.g., where government regulations require recordkeeping of certain communications) a system and/or method as disclosed herein may be configured to prevent an electronic message from being transmitted (e.g., regardless of user selection) using a recordless messaging system if the desired degree of recordlessness requires a highly recordful transmission.

In yet another exemplary embodiment, it is contemplated that a system and/or method as disclosed herein may have one or more of its components residing with a sending device (e.g., as client-side machine-readable instructions present on a user input device, such as device 210, 310). In another example, all of the components of a method and/or system for determining a desired degree of recordlessness and determining an appropriate messaging functionality based thereon reside on and/or are closely associated therewith a sending device. In yet another example, one or more of the components may reside on a remote computing device (e.g., a remote server computer connected over the Internet and/or other network).

As discussed above, a degree of recordlessness may be increased by a variety of ways. In one example, header information and message content of an electronic message are displayed so that header information and message content are not displayed at the same time. In one aspect, separation of header information from message content reduces the traceability of the electronic message. To further reduce traceability of an electronic message, header information may be automatically deleted at a first predetermined time and message content may be automatically deleted at a second predetermined time (e.g., after message content is viewed). In one such example, the first and second predetermined times may occur sequentially (e.g., deleting header information upon displaying message content and deleting message content upon closing a display of message content), simultaneously (e.g., deleting message content and associated header information upon closing a display of message content), or out of order such that the second predetermined time occurs before the first predetermined time (e.g., displaying message content first, deleting message content, displaying header information, then deleting header information). Exemplary implementations of electronic messaging functionalities with a high degree of recordlessness are illustrated below with respect to FIG. 13.

FIG. 13 illustrates one implementation of a system 1300 for electronic messaging having a high degree of recordlessness. System 1300 depicts an electronic message 1305 being sent from one user to another. System 1300 may include any number of computers, such as the two user computers 1310 and 1315, coupled to a network 1320. Network 1320 facilitates communication between computer 1310 and computer 1315. In one example, system 1300 may be a closed system that may utilize open network structures (e.g., the Internet) for communication with users, but that does not utilize open or third-party messaging systems (e.g., industry standard email) that may increase the chance of message logging and impact the recordless nature of an electronic message. System 1300 allows users of computers 1310 and 1315 to communicate with each other via one or more electronic messages, such as electronic message 1305 over network 1320. As will be described in further detail hereinafter, several aspects of system 1300 reduce traceability of electronic messages, such as electronic message 1305. In one example, electronic message 1305 is automatically deleted from system 1300 after it is viewed by the recipient to ensure that electronic message 1305 cannot be forensically recreated and to ensure there is no record of electronic message 1305 ever existing on system 1300 thereafter.

Although computers 1310 and 1315 are illustrated as workstation computers, any computing device may be utilized in creating and/or viewing electronic messages. Example computers are discussed below with respect to FIG. 14. System 1300 may include one or more server computers and/or one or more client devices. In one example, system 1300 may reside substantially on a single server computer. In another example, system 1300 may be distributed across two or more server computers. In yet another example, system 1300 may be distributed across a plurality of user computers without a server computer, such as in a peer-to-peer environment. In one such example, components of an exemplary messaging system with a high degree of recordlessness and/or their functionality (e.g., storage of header information and message content, display generation, reply generation, etc.) may occur at a recipient's user computer. In still another example, system 1300 may be distributed across one or more server computers and one or more user computers. One or more relay servers or other systems may be utilized between server computers and/or user computers. Computer 1310 may include a system and/or method as described above for determining a desired degree of recordlessness. In such an example, computer 1310 may have access to other messaging functionalities for which appropriateness for sending an electronic message may be determined based on the desired degree of recordlessness.

An exemplary electronic message 1305 is communicated by a sending user utilizing computer 1310 to system 1300 for further communication to a recipient user. Exemplary system 1300 includes an electronic message receiver 1325 for receiving one or more electronic messages, such as electronic message 1305. Electronic message receiver 1325 is in communication with an electronic message storage module 1330. An electronic message storage module, such as electronic message storage module 1330, stores electronic messages received by electronic message receiver 1325 utilizing one or more particular data storage methodologies. Many data storage methodologies will be recognized by those skilled in the art and those chosen for use with an electronic message storage module may be based on the particular implementation of the messaging system and method. Example data storage methodologies may include, but are not limited to, one or more tables, a database, a file system, and any combinations thereof. In one example, as will be described in greater detail below, electronic message storage module 1330 stores header (“container”) information and message content separate from each other to minimize correlation by a third party between identifying information regarding the electronic message (e.g., identification of sender, recipient, date/time of message, location of message) in the header information and the content of the message. In an alternate example, message content and header information may be stored together and separated during display. In one implementation, header information and message content are never stored or displayed together. In such a case, a correlation (e.g., a non-identifying message ID) may be utilized to associate the two components.

Electronic message 1305 as communicated to system 1300 in the example of FIG. 13 includes a recipient address 1335 (i.e., identifying header information) and a message content 1340. A recipient address, such as recipient address 1335 may be an indicator that identifies a particular desired recipient of an electronic message, such as electronic message 1305. In one example, a recipient address may be a unique identifier (e.g., a screen name, a login name, a messaging name, etc.) established specifically for use with system 1300 at user registration with the system. In another example, a recipient address may be a pre-established electronic mail (email) address, text messaging address, instant messaging address, Short Messaging Service (SMS) address, a telephone number (e.g., a home, work, mobile telephone number), BLACKBERRY personal identification number (PIN), or the like, that is associated with the recipient and provided by a third-party provider. Example third-party providers include, but are not limited to, a web-based commercial fee and fee-free provider (e.g., YAHOO, HOTMAIL, AMERICA ONLINE, etc.), an Internet service provider (e.g., AMERICA ONLINE, MSN, cable operator, telephone company, etc.), a telephone provider (e.g., VERIZON, CINGULAR, etc.), BLACKBERRY provider, an employer, an educational institution, and other email providers. The third-party address may be chosen by a user as their unique identifier at registration. In an alternative implementation, a sending user may know a third-party address of an intended recipient and use it as a recipient address when generating electronic message 1305. In such an implementation, it is possible that the intended recipient is not a registered user of system 1300. In one example, system 1300 may optionally include an external system communication generator 1345 configured to send a notification message to the third-party system associated with the recipient address used with electronic message 1305. External system communication generator 1345 is in communication with the appropriate network for communication with the corresponding third-party address for delivering the notification message. In one example shown in FIG. 13, external system communication generator 1345 is shown connected to the Internet. In one example, a notification message may include an indication that someone has sent the desired recipient an electronic message on system 1300 and that the intended recipient may register to use system 1300. The notification message may include directions (e.g., a hyperlink) to a publicly available portion of system 1300 for registration.

System 1300 may optionally include a message ID generator 1350. As described in further detail below, message ID generator 1350 may generate a message ID for each electronic message received by system 1300. The message ID is associated with the corresponding message. A message ID is used to associate a container (i.e., header) information with a corresponding separately-stored message content. In one example, a message ID may be created using a unique 1328 bit, randomly generated number. System 1300 may include a correlation between header information and message content in a variety of ways including, but not limited to, a database, a lookup table, an entry in a file system, and any combinations thereof. Utilizing a message ID associated with an electronic message, such as electronic message 1305, system 1300 may handle (e.g., store, deliver, display, etc.) a header information and a message content of a particular electronic message separately with the ability to correlate the two at a later time. Thus, a message content may be handled without any of the identifying header information. A message ID may contain unique and/or non-unique information. For example, a message ID may include a sequence number (e.g., 1, 2, 3, 4, etc.) identifying a number of a message amongst a group of messages. A sequence number may be re-used. For example, when an electronic message with a sequence number of “1” is viewed and subsequently deleted, sequence numbers for remaining electronic messages may be adjusted so that the electronic message having sequence number “2” is renumbered to number “1” and so forth. In another example, a message ID may include a sequence number combined with a unique user identifier (e.g., a user ID, a login ID, a session ID etc.).

System 1300 may optionally include a reply ID generator 1355. As described further below, reply ID generator 1355 generates a reply ID for each electronic message received by system 1300. The reply ID associates an electronic message, such as electronic message 1305, with the sender of the electronic message. In one example, a reply ID may include no information that in itself would identify a sender of an electronic message to a third party that does not have access to the correlation maintained by the messaging system. System 1300 may include a correlation between a reply ID and a corresponding message sender in a variety of ways, including, but not limited to, a database, a lookup table, an entry in a file system, and any combinations thereof. In one aspect, a reply ID associated with an electronic message allows the header information and/or the message content of the electronic message to include no information about the sender of the message that itself provides a traceable identity of the sender. A recipient may still send a reply electronic message to the original sender. Additionally, a third-party that may intercept, log, or otherwise come in possession of the header information and/or the message content will not be able to trace the electronic message to the sender without also gaining access to the correlation maintained by system 1300. A reply ID may include a variety of different identifiers that allow a messaging system, such as system 1300, to direct a reply electronic message back to a sender of the original electronic message. In one example, a reply ID may be created using a randomly generated number (e.g., a 128 bit, randomly generated number).

System 1300 includes a display generator 1360 in communication with electronic message storage module 1330. Display generator 1360 is configured to provide information representing a display image for display on a user computer, such as user computers 1310, 1315. Example display images include, but are not limited to, a user login display, a display listing information representing available electronic messages for viewing, a display for entering an electronic message, a display of a message content of an electronic message, a display for entering a reply electronic message, and any combinations thereof. In one example, display generator 1360 may be configured to utilize a message ID in generating a first information 1365 representing a first display image including at least some of the header information for electronic message 1305. Display generator 1360 may also be configured to generate a second information 1370 representing a second display image including message content 1340 of electronic message 1305. FIG. 13 illustrates first and second information 1365, 1370 communicated with computer 1315 for display to a recipient user. In this example, display generator 1360 generates first and second information 1365, 1370 in a manner that does not allow the first and second display images to be displayed at the same time. Separate display of header information and message content for an electronic message reduces traceability of the electronic message. In one aspect, screenshot logging at a computer, such as computer 1315, may not capture both header information and message content simultaneously. Additionally, separation of header information and message content physically and/or temporally during communication to a user computer over an open network, such as the Internet, can thwart misuse of the electronic message by reducing the ability of intercepting both components of the electronic message.

Display generator 1360 may utilize any of a variety of well known display generation methodologies and/or protocols for creating information representing a displayable image. Example methodologies/protocols include, but are not limited to, hypertext markup language (HTML), extensible markup language (XML), direct graphic generation, and any combinations thereof. In one example, system 1300 resides on one or more server computers and display generator 1360 includes and/or utilizes a web server application to generate information representing web-browser-displayable images that may be viewed by a user computer including a web browser. In another example, display generator 1360 may be configured to instruct a browser or other application of a user computer displaying a display image according to the present invention to not cache any of the information related to the display image.

System 1300 may further include a deletion module 1375 in communication with electronic message storage module 1330. Deletion module 1375 is configured to delete header information and/or message content from system 1300 after a predetermined amount of time. In one example, deletion module 1375 is configured to automatically delete header information and corresponding message content immediately after the message content is displayed. In another example, a deletion module (e.g., deletion module 1375) is configured to automatically delete header information upon display of a corresponding message content. In yet another example, a deletion module (e.g., deletion module 1375) is configured to automatically delete message content upon a display of the message content being closed. In still another example, a deletion module is configured to automatically delete header information and/or message content, whether or not they have been viewed, after a predetermined time (e.g., twenty-four hours after being received). In still yet another example, a deletion module is configured to automatically delete header information and/or message content a predetermined time (e.g., twenty-four hours) after first being displayed. In a further example, a predetermined amount of time may include a predetermined number of viewings (other than a single viewing) of a particular electronic message (e.g., an electronic message is deleted after 20 views). In still a further example, a deletion module (e.g., deletion module 1375) is configured to automatically delete header information upon display of a corresponding message content and to automatically delete message content upon a display of the message content being closed. Combinations of deletion protocols, such as these examples, are also contemplated.

In an alternate implementation, system 1300 may include a display-based keyboard generator 1380. Display-based keyboard generator 1380 is configured to generate a display-based keyboard that may be included with a display image generated by display generator 1360. A display-based keyboard can be utilized by a user (e.g., through mouse click or touch screen depression) to input information (e.g., username, password, recipient address, message content) without the use of the standard keyboard associated with the user computer. In this way interception by keyboard (keystroke) logging hardware and/or software resident on the user computer, such as computers 1310, 1315. In one example, a display-based keyboard generator may utilize FLASH technology commercially available from Macromedia Inc. In another example, a display-based keyboard generator may utilize Java technology commercially available from Sun Microsystems. In one aspect a FLASH-based keyboard may randomly place spaces between characters in the on-screen keyboard to further prevent interception of the message. Although this is a relatively slow data entry method, a user can be more assured that their information is not being logged and/or intercepted.

System 1300 may also optionally include a reply message receiver 1385. Reply message receiver 1385 is configured to receive a reply message to one or more original electronic messages viewed by a recipient. In one aspect, a sender of an original electronic message may be determined from an identifying characteristic included, or associated, with the electronic message. Example identifying characteristics include, but are not limited to, a reply ID, an email address, a username, a display name, login ID, and any combination thereof. In one example, a reply ID of the original electronic message may be utilized in generating a reply message. In one example, a reply message as communicated by computer 1315 to system 1300 need only include a message content 1390. System 1300 may include a reply generator 1395. Reply generator 1395 may be configured to utilize the original reply ID to associate message content 1390 and any corresponding header information with the original electronic message sending user. Message ID generator 1350 may be configured to generate a message ID for the reply electronic message (i.e., message content 1390 and corresponding header information). Reply ID generator 1355 may be configured to generate a new reply ID for the reply message and electronic message storage module 1330 may store message content 1390 and corresponding header information separately for later display to the user (original sender).

FIG. 13 illustrates exemplary implementations of a messaging system with a high degree of recordlessness. Variations to system 1300 and the network environment of system 1300 are described in U.S. Patent Application Publication No. 2007/0038715 A1 to Collins et al., which is incorporated herein by reference in its entirety. Other methodologies for increasing the recordlessness of an electronic messaging system employ, for example, FLASH technology to display message content (e.g., only displaying message content when and action, such as mouse-over, occurs), deletion of one or more components of an electronic message, use of encryption technology during storage and/or transmission, and any combinations thereof.

It is to be noted that the aspects and embodiments described herein may be conveniently implemented using a machine (e.g., a general purpose computing device) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art.

Such software may be a computer program product that employs a machine-readable medium. A machine-readable medium may be any medium that is capable of storing and/or encoding a sequence of instructions for execution by a machine (e.g., a computing device) and that causes the machine to perform any one of the methodologies and/or embodiments described herein. Examples of a machine-readable medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as the possibility of including a collection of physically separate media, such as, for example, a collection of compact disks or one or more hard disk drives in combination with a computer memory.

Examples of a computing device include, but are not limited to, a computer workstation, a terminal computer, a server computer, a handheld device (e.g., tablet computer, a personal digital assistant “PDA”, a mobile telephone, a BLACKBERRY mobile device, etc.), a web appliance, a network router, a network switch, a network bridge, any machine capable of executing a sequence of instructions that specify an action to be taken by that machine, and any combinations thereof. In one example, a general purpose computing device may include and/or be included in, a kiosk.

FIG. 14 shows a diagrammatic representation of one implementation of a machine/computing device in the exemplary form of a computer system 1400 within which a set of instructions for causing the device to perform any one or more of the aspects and/or methodologies of the present disclosure may be executed. Computer system 1400 includes a processor 1405 and a memory 1410 that communicate with each other, and with other components, via a bus 1415. Bus 1415 may include any of several types of bus structures including, but not limited to, a memory bus, a memory controller, a peripheral bus, a local bus, and any combinations thereof, using any of a variety of bus architectures.

Memory 1410 may include various components (e.g., machine readable media) including, but not limited to, a random access memory component (e.g, a static RAM “SRAM”, a dynamic RAM “DRAM”, etc.), a read only component, and any combinations thereof. In one example, a basic input/output system 1420 (BIOS), including basic routines that help to transfer information between elements within computer system 1400, such as during start-up, may be stored in memory 1410. Memory 1410 may also include (e.g., stored on one or more machine-readable media) instructions (e.g., software) 1425 embodying any one or more of the aspects and/or methodologies of the present disclosure. In another example, memory 1410 may further include any number of program modules including, but not limited to, an operating system, one or more application programs, other program modules, program data, and any combinations thereof.

Computer system 1400 may also include a storage device 1430. Examples of a storage device (e.g, storage device 1430) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 1430 may be connected to bus 1415 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1430 may be removably interfaced with computer system 1400 (e.g., via an external port connector (not shown)). Particularly, storage device 1430 and an associated machine-readable medium 1435 may provide nonvolatile and/or volatile storage of machine-readable instructions, data structures, program modules, and/or other data for computer system 1400. In one example, software 1425 may reside, completely or partially, within machine-readable medium 1435. In another example, software 1425 may reside, completely or partially, within processor 1405.

Computer system 1400 may also include an input device 1440. In one example, a user of computer system 1400 may enter commands and/or other information into computer system 1400 via input device 1440. Examples of an input device 1440 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 1440 may be interfaced to bus 1415 via any of a variety of interfaces (not shown) including, but not limited to, a serial interface, a parallel interface, a game port, a USB interface, a FIREWIRE interface, a direct interface to bus 1415, and any combinations thereof.

A user may also input commands and/or other information to computer system 1400 via storage device 1430 (e.g., a removable disk drive, a flash drive, etc.) and/or a network interface device 1445. A network interface device, such as network interface device 1445 may be utilized for connecting computer system 1400 to one or more of a variety of networks, such as network 1450, and one or more remote devices 1455 connected thereto. Examples of a network interface device include, but are not limited to, a network interface card, a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 1450, may employ a wired and/or a wireless mode of communication. In general, any network topology may be used. Information (e.g., data, software 1425, etc.) may be communicated to and/or from computer system 1400 via network interface device 1445.

Computer system 1400 may further include a video display adapter 1460 for communicating a displayable image to a display device, such as display device 1465. Examples of a display device include, but are not limited to, a liquid crystal display (LCD), a cathode ray tube (CRT), a plasma display, and any combinations thereof. In addition to a display device, a computer system 1400 may include one or more other peripheral output devices including, but not limited to, an audio speaker, a printer, and any combinations thereof. Such peripheral output devices may be connected to bus 1415 via a peripheral interface 1470. Examples of a peripheral interface include, but are not limited to, a serial port, a USB connection, a FIREWIRE connection, a parallel connection, and any combinations thereof.

A digitizer (not shown) and an accompanying pen/stylus, if needed, may be included in order to digitally capture freehand input. A pen digitizer may be separately configured or coextensive with a display area of display device 1465. Accordingly, a digitizer may be integrated with display device 1465, or may exist as a separate device overlaying or otherwise appended to display device 1465.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A computerized method of monitoring an electronic message at the point of generation, the method comprising:
receiving information from a user via an electronic interface for inclusion in an electronic message;
determining a desired degree of recordlessness for the electronic message; and
choosing an appropriate electronic messaging functionality for generating and/or transmitting the electronic message based on the desired degree of recordlessness.

2. A method according to claim 1, wherein said determining a desired degree of recordlessness for the electronic message includes comparing at least part of the information received to one or more rules.

3. A method according to claim 1, wherein said choosing includes displaying a notification based on the desired degree of recordlessness to the user.

4. A method according to claim 1, wherein said choosing includes displaying one or more choices of electronic messaging functionalities available to the user that have an ability to generate and/or transmit an electronic message with a degree of recordlessness high enough to meet or exceed the desired degree of recordlessness.

5. A method according to claim 1, wherein said choosing includes displaying an indication that one or more electronic messaging functionalities available to the user has a degree of recordlessness that exceeds the desired degree of recordlessness.

6. A method according to claim 1, wherein said choosing includes displaying an indication that one or more electronic messaging functionalities available to the user does not have an ability to generate and/or transmit an electronic message with a degree of recordlessness high enough to meet or exceed the desired degree of recordlessness.

7. A method according to claim 6, wherein said choosing an appropriate electronic messaging functionality includes receiving from the user an instruction to generate and/or transmit the electronic message utilizing a messaging functionality that does not have a degree of recordlessness high enough to meet or exceed the desired degree of recordlessness.

8. A method according to claim 1, wherein said choosing includes automatedly generating and/or transmitting the electronic message.

9. A method according to claim 8, wherein said choosing an appropriate electronic messaging functionality includes automatedly generating and/or transmitting the electronic message utilizing a messaging functionality having a degree of recordlessness high enough to meet or exceed the desired degree of recordlessness.

10. A method according to claim 8, wherein said choosing an appropriate electronic messaging functionality includes automatedly preventing the generation and/or transmission of the electronic message by at least one restricted messaging functionality of the one or more messaging functionalities based on the degree of recordlessness of the at least one restricted messaging functionality exceeding the desired degree of recordlessness.

11. A method according to claim 1, wherein said electronic interface is an electronic interface for a first one of a plurality of available electronic messaging functionalities.

12. A method according to claim 11, wherein said choosing an appropriate electronic messaging functionality includes generating and/or transmitting the electronic message utilizing the first one of the plurality of available electronic messaging functionalities.

13. A method according to claim 11, wherein said choosing an appropriate electronic messaging functionality includes generating and/or transmitting the electronic message utilizing a second one of the plurality of available electronic messaging functionalities.

14. A method according to claim 1, wherein said determining a desired degree of recordlessness occurs substantially corresponding to the time of input of the information into the electronic interface.

15. A computerized system for monitoring an electronic message at the point of creation, the system comprising:
a first electronic interface for receiving information for inclusion in one or more electronic messages from a sender, said one or more electronic messages for transmission to a recipient utilizing one or more electronic messaging functionalities, each of the one or more electronic messaging functionalities having a degree of recordlessness;
a first database including a set of rules for determining a desired degree of recordlessness for said one or more electronic messages; and
a message monitor in communication with said first electronic interface, said first database, and said one or more electronic messaging functionalities for monitoring information received by said first electronic interface and comparing at least part of said received information to said set of rules to determine said desired degree of recordlessness prior to transmission of said one or more messages and to determine if the degree of recordlessness of any of said one or more electronic messaging functionalities matches the desired degree of recordlessness.

16. A system according to claim 15, further comprising a notice generator in communication with said message monitor for generating a notice to said sender of said desired degree of recordlessness and/or the appropriateness of utilizing an electronic messaging functionality of the one or more electronic messaging functionalities to generate and/or transmit the one or more electronic messages.

17. A system according to claim 15, wherein said message monitor compares said at least one of said one or more messages to said set of rules during receipt of said at least one of said one or more messages by said first electronic interface.

18. A system according to claim 15, wherein said message monitor is configured to use comparison information regarding the matching of the desired degree of recordlessness and the degree of recordlessness of said one or more electronic messaging functionalities to facilitate at least one of said one or more electronic messaging functionalities to generate and/or transmit the electronic massage based on said comparison information.

19. A system for electronic messaging, the system comprising:
a sender device including an interface for receiving information for inclusion in an electronic message;
a first electronic messaging subsystem, said first electronic messaging subsystem having a first degree of recordlessness;
a second electronic messaging subsystem, said second electronic messaging subsystem having a second degree of recordlessness that differs from said first degree of recordlessness;
a first database including a set of rules for determining a status of said electronic message, said set of rules including criteria for determining said status based on whether said electronic message should be sent at said first or second degree of recordlessness; and
a message monitor in communication with said interface, said first database, said first electronic messaging subsystem, and said second electronic messaging subsystem, said message monitor comparing said electronic message to said set of rules to determine said status prior to transmission of said electronic message.

20. A machine-readable medium containing machine executable instructions implementing a method of monitoring an electronic message at the point of generation, the instructions comprising:
a set of instructions for receiving information from a user via an electronic interface for inclusion in an electronic message;
a set of instructions for determining a desired degree of recordlessness for the electronic message; and
a set of instructions for choosing an appropriate electronic messaging functionality for generating and/or transmitting the electronic message based on the desired degree of recordlessness.

21. A machine-readable medium according to claim 20, wherein said set of instructions for determining a desired degree of recordlessness for the electronic message includes a set of instructions for comparing at least part of the information received to one or more rules in one or more electronic databases.

22. A machine-readable medium according to claim 20, wherein said set of instructions for choosing includes a set of instructions for displaying a notification based on the desired degree of recordlessness to the user.

23. A machine-readable medium according to claim 20, wherein said set of instructions for choosing includes a set of instructions for displaying one or more choices of electronic messaging functionalities available to the user that have an ability to generate and/or transmit an electronic message with a degree of recordlessness high enough to meet or exceed the desired degree of recordlessness.

24. A machine-readable medium according to claim 20, wherein said set of instructions for choosing includes a set of instructions for displaying an indication that one or more electronic messaging functionalities available to the user has a degree of recordlessness that exceeds the desired degree of recordlessness.

25. A machine-readable medium according to claim 20, wherein said set of instructions for choosing includes set of instructions for displaying an indication that one or more electronic messaging functionalities available to the user does not have an ability to generate and/or transmit an electronic message with a degree of recordlessness high enough to meet or exceed the desired degree of recordlessness.

26. A machine-readable medium according to claim 25, wherein said set of instructions for choosing an appropriate electronic messaging functionality includes a set of instructions for receiving from the user an instruction to generate and/or transmit the electronic message utilizing a messaging functionality that does not have a degree of recordlessness high enough to meet or exceed the desired degree of recordlessness.

27. A machine-readable medium according to claim 20, wherein said set of instructions for choosing includes a set of instructions for automatedly generating and/or transmitting the electronic message.

28. A machine-readable medium according to claim 27, wherein said set of instructions for choosing an appropriate electronic messaging functionality includes a set of instructions for automatedly generating and/or transmitting the electronic message utilizing a messaging functionality having a degree of recordlessness high enough to meet or exceed the desired degree of recordlessness.

29. A machine-readable medium according to claim 27, wherein said set of instructions for choosing an appropriate electronic messaging functionality includes a set of instructions for automatedly preventing the generation and/or transmission of the electronic message by at least one restricted messaging functionality of the one or more messaging functionalities based on the degree of recordlessness of the at least one restricted messaging functionality exceeding the desired degree of recordlessness.

30. A machine-readable medium according to claim 20, wherein the electronic interface is an electronic interface for a first one of a plurality of available electronic messaging functionalities.

31. A machine-readable medium according to claim 30, wherein said set of instructions for choosing an appropriate electronic messaging functionality includes a set of instructions for generating and/or transmitting the electronic message utilizing the first one of the plurality of available electronic messaging functionalities.

32. A machine-readable medium according to claim 30, wherein said set of instructions for choosing an appropriate electronic messaging functionality includes a set of instructions for generating and/or transmitting the electronic message utilizing a second one of the plurality of available electronic messaging functionalities.
